(19) United States
(12) Patent Application Publication
(10) Pub. No.: US 2026/0207297 A1
(43) Pub. Date: Jul. 23, 2026

(54) ENDODONTIC INSTRUMENT HAVING IMPROVED FIT OF THE TOOTH CANAL GEOMETRY

(71) Applicant: FKG Dentaire Sàrl, Le Crêt-du-Locle (CH)

(72) Inventors: Adham Abdel Azim, Orinda, CA (US); Fabien Rino Rémy Gigon, Colombier (CH); Sébastien Fran¿ois Barré, St. Barthélemy (CH)

(73) Assignee: FKG Dentaire Sàrl, Le Crêt-du-Locle (CH)

(21) Appl. No.: 19/133,365

(22) PCT Filed: Dec. 2, 2022
(86) PCT No.: PCT/IB2022/061697

§ 371 Date: May 28, 2025

(51) Int. Cl. A61C 5/42

(52) U.S. Cl. CPC A61C 5/42; A61C 2201/007

(57) ABSTRACT

The present disclosure concerns an endodontic instrument made of a shape memory alloy and having a working part. The working part has a working profile comprising a substantially straight apical segment and an intermediate segment. The intermediate segment includes a first curvature, having a first peak, and a second curvature having a second apex larger than the first peak. An apical envelope of the apical segment forms an apical taper angle relative to the longitudinal axis. An intermediate envelope of the intermediate segment, tangent to the first and second peaks, forms an intermediate angle relative to the longitudinal axis, the apical angle being smaller than the intermediate angle.

### TECHNICAL DOMAIN

The present invention relates to the field of endodontics and, in particular, to an improved endodontic instrument for operating within the tooth canal, dental pulp and surrounding area, and more particularly to an endodontic instrument that better fit the tooth canal geometry and allows for better removal of the debris from the canal.

### RELATED ART

The cleaning and shaping of a root canal of a tooth for the purpose of receiving filling materials is typically carried out by means of an endodontic instrument having a cutting section or so-called working part. The purpose of the working part is to form, trim, and clean the inside walls of the root canal in order to prepare it for receiving the treatment materials and then a filling material, in order to exclude any oxygen that could enable bacteria to develop in the tooth and particularly in the vicinity of the root.

The working part of the endodontic instrument has typically a nearly cylindrical or conical envelope with axially symmetric geometry of the file. and one or more cutting edges wound helically along said working part. The endodontic instrument can be configured to “shave” the walls of the canal, in other words to cut into the dentin, without modifying the natural shape of the canal by following the path thereof. However, recent studies indicate that excessive removal of dentin is not recommended because the tooth is weakened as a consequence of this procedure.

Root canal morphology vary greatly among patients. Longitudinal canal profiles often have an irregular oval cross section along their length and can comprise one or more narrow and curved portions.

Most current endodontic instruments have a straight geometry and may have a certain flexibility that enables them to adapt to some extent to the longitudinal profile of the root canal. However, such flexibility cannot guarantee effective cleaning of the entire wall when the latter has variations in curvature and cross section.

Furthermore, the envelope for the space brushed by a standard endodontic instrument driven in rotation about its longitudinal axis is nearly cylindrical or conical due to the axially symmetric geometry of the instrument, such that the walls of a root canal with an oval cross section cannot be brushed by a single endodontic instrument, but require a series of endodontic instruments with different diameters. The practitioner is, therefore, compelled to change endodontic instruments during a procedure, starting with small and then progressively larger diameters, which is not only tedious but also does not guarantee that the walls are cleaned effectively without damaging the dentin.

There is thus a need for an endodontic instrument that satisfy the requirements of practitioners, namely, an endodontic instrument being flexible enough to follow the profile of the canal, and having a geometry allowing it to contact the rough and uneven areas of the canal walls, and to brush canal walls such as to remove the inner biofilm without cutting into the dentin.

From the materials perspective, endodontic instruments have generally been made from medical-grade metals, including stainless steels and various machinable alloys. Modern endodontic instruments are made from shape memory alloys, such as nickel-titanium alloys, including “Nitinol™” or “NiTi.” The endodontic instruments made of nickel and titanium exhibit superior flexibility and torsional properties as compared to stainless steel instruments.

Document WO2016004541A1 discloses an endodontic instrument for cleaning the root canal that follows the natural geometry of the canal. The endodontic instrument comprises a working sector made of a shape memory alloy having a transition temperature. The shape memory alloy can be deformed below the transition temperature but returns to its pre-deformed (“remembered”) shape when heated at or above the transition temperature. The working sector includes a free end section, destined to engage in the root canal, and a second active segment. When below the transition temperature, the second active segment is substantially straight and, at or above the transition temperature, the second active segment has a curved shape configured to contact and brush the surface of the canal walls.

### SUMMARY

The present disclosure concerns an endodontic instrument for cleaning a root canal. The endodontic instrument is made of a shape memory alloy and has a working part destined to be engaged in the root canal and generally extending along a longitudinal axis, between an apical end and a shaft. The working part has a working profile comprising an apical segment, substantially straight relative to the longitudinal axis, and an intermediate segment, extending between the apical segment and the shaft. The intermediate segment consists of a first curvature, having a first peak relative to the longitudinal axis, and a second curvature, having a second peak relative to the longitudinal axis and larger than the first peak. An apical envelope of the apical segment forms an apical taper angle relative to the longitudinal axis, and an intermediate envelope of the intermediate segment, tangent to the first and second peaks, forms an intermediate angle relative to the longitudinal axis, the apical angle being smaller than the intermediate angle.

The working part of the endodontic instrument allows for the endodontic instrument to better fit of the tooth canal geometry and to increase removal of the debris from the canal. The working part of the endodontic instrument can be easily introduced into the root canal.

### SHORT DESCRIPTION OF THE DRAWINGS

Exemplar embodiments of the invention are disclosed in the description and illustrated by the drawings in which:

FIG. 1 illustrates an endodontic instrument comprising a working part, according to an embodiment;

FIG. 2 illustrates the working part with a working profile according to an embodiment; and

FIG. 3 shows a graph reporting the transition temperature of a nitinol alloy comprising 56% nickel and about 44% titanium by weight.

### EXAMPLES OF EMBODIMENTS

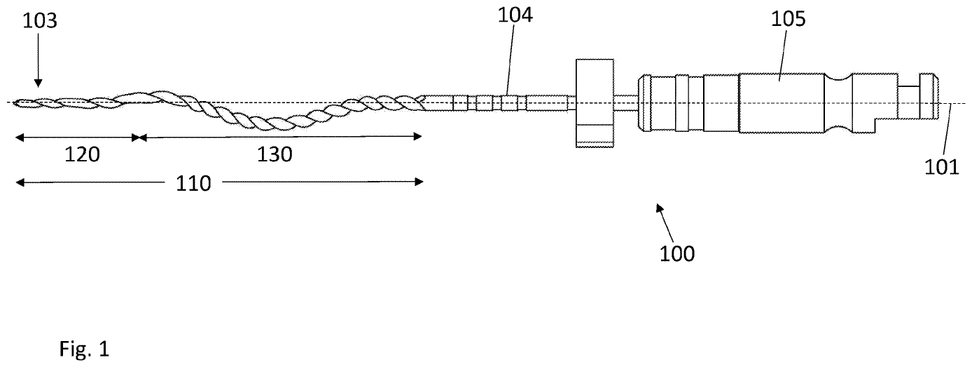

FIG. 1 illustrates an endodontic instrument 100 for cleaning a root canal, according to an embodiment. The endodontic instrument 100 comprises a working part 110 that generally extends along a longitudinal axis 101, between an apical end 103 and a shaft 104 of the endodontic instrument 100. The working part 110 is destined to be engaged in the root canal to be treated. The endodontic instrument 100 further comprises a shank 105 secured to the shaft 104 and destined to be mounted on a rotating support to cause the endodontic instrument 100 to rotate about its longitudinal axis 101. Instead of a shank, the endodontic instrument 100 may comprises a handle 105 such as to manually rotate the endodontic instrument 100.

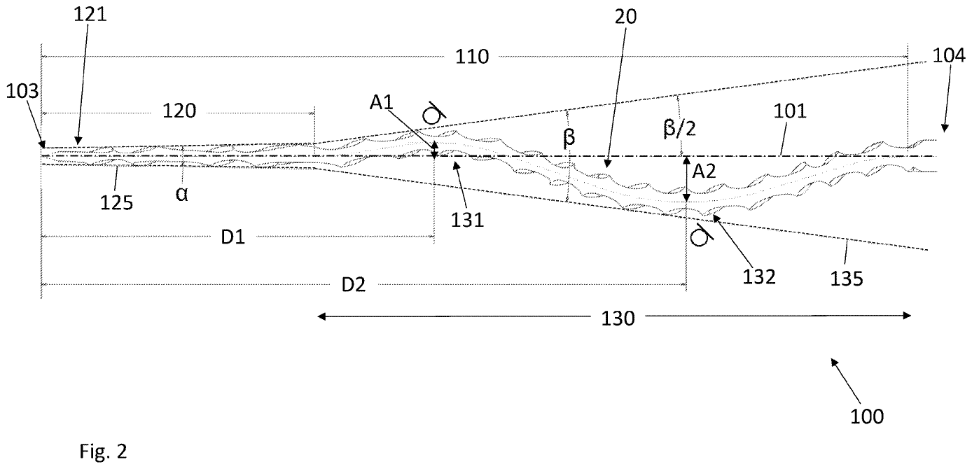

FIG. 2 illustrates the working profile according to an embodiment. The working profile of the working part 110 comprises of an apical segment 120, substantially straight relative to the longitudinal axis 101, and an intermediate segment 130, extending between the apical segment 120 and the shaft 104. The apical segment 120 and the intermediate segment 130 are arranged sequentially from the apical end 103 to the shaft 104.

The apical segment 120 may have a tapered section from the intermediate segment 130 toward the apical end 103. As shown in FIG. 2, an apical envelope 125 of the apical segment 120 forms an apical taper angle a relative to the longitudinal axis 101.

The intermediate segment 130 consists of a first curvature 131 and a second curvature 132. The first curvature 131 has a first peak A1 relative to the longitudinal axis 101 and the second curvature 132 has a second peak A2 relative to the longitudinal axis 101. The first and second peaks A1, A2 respectively corresponds to the maximal amplitude of the first and second curvature 131, 132, i.e., the greatest distance of the first and second curvature 131, 132 relative to the longitudinal axis 101.

In a possible configuration, the first curvature 131 can be curved along the same plane as the second curvature 132, but in an opposite direction.

The first peak A1 and the second peak A2 are respectively located at a first distance D1 and a second distance D2 from the apical end 103 (towards the shaft 104). The first peak A1 is smaller than the second peak A2, such that the intermediate segment 130 has a tapered shape from the shaft 104 toward the apical end 103. As shown in FIG. 2, an intermediate envelope 135 of the intermediate segment 130, tangent to the first and second peaks A1, A2, forms an intermediate taper angle ß relative to the longitudinal axis 101.

In an aspect, the apical taper angle & is smaller than the intermediate taper angle B. The small apical taper angle a corresponds to the tapering of a narrower endodontic instrument typically used in earlier stages (when entering the canal). The larger intermediate taper angle β of the intermediate envelope 135 corresponds to the tapering of a wider endodontic instrument as used in the final stage or stages of a root canal procedure.

The endodontic instrument 100 can be considered as a non-uniform taper instrument (or non-standard instrument of type 4, according to the international standard ISO 3630-1, third edition 2019 08 (section 4). The endodontic instrument 100 can further be considered as a Reamer of type K according to the same international standard (section 8).

The working part 110 with the intermediate envelope 135 may act as a whip that brushes against the walls of the canal and removes the soft portions that can line the surface thereof. The function of the working part 110 is that of cleaning the surface of the canal walls, regardless of the geometry of the canal. The shape of the working part 110 allows for better removal of the debris in the canal.

The effective tapering, i.e., the apical taper angle a and the intermediate taper angle β may be constant or varied along the length of the working part 110.

In one aspect, the apical taper angle a may be between 0° and 7°. The intermediate taper angle (may be between 4° and 30°.

In one aspect, the length of the apical segment 120 is between about 2 mm and 5 mm.

The ratio of the first distance D1 to the length of the working part 110 is between 0.45 and 0.18.

The ratio of second distance D2 to the length of the working part 110 is between 0.65 and 0.3.

For example, in the case of a K-type endodontic instrument having a 16 mm long working part 110, the apical segment 120 may have a length between 3 and 5 mm. The first distance D1 may be between 3 mm and 7 mm. The second distance D2 may be between 5 mm and 10 mm.

In a preferred configuration, the apical segment 120 of the endodontic instrument 100 is coaxial with the longitudinal axis 101. The working part 110 is also preferably coaxial with the longitudinal axis 101.

The endodontic instrument 100 preferably includes cutting edges 20 along a working part 110. The cutting edges 20 are intended for cutting the material along the walls of the root canal. The cutting edges 20 may be helical cutting edges such as those in traditional helical endodontic instruments, or other cutting edges known in the art. Alternately, the cutting edges 20 could be angled corners extending along a portion of the length of a polygonal, fluteless rod. In certain embodiments, the cutting edges 20 alternate or are selectively patterned based on the specific working part 110 profile of the endodontic instrument 100.

In some embodiments, the apical segment 120 can be terminated at the apical end 103 by a tip 121 that does not comprise cutting edges. The tip 121 can be rounded. The tip can comprise an angular cutting area such that the tip is configured to perform the functions of guiding the endodontic instrument in the canal and cutting, as described in international patent application WO2021240387A1 by the present applicant.

The endodontic instrument 100 can be made of a shape memory alloy having a transition temperature. Below the transition temperature, the working part 110 of the endodontic instrument 100 is malleable and can be plastically deformed. Above the transition temperature, the working part 110 goes back to a memorized shape and behaves elastically.

The working profile of the working part 110 can be obtained during manufacturing of the endodontic instrument 100. More particularly, a molding or forming operation can be performed on the working part 110 of the endodontic instrument 100 into a molded shape corresponding the working profile. During molding, the working part 110 is heated at a heating temperature, for example between 400° C. and 600° C., to memorize the molded shape.

In a preferred embodiment, the shape memory alloy of the endodontic instrument 100 can have a transition temperature that is close to the body temperature. For example, the transition temperature can be around 30° C. to 36° C. When the endodontic instrument 100 is introduced in the root canal, the endodontic instrument 100 is at a temperature that is close to room temperature, below the transition temperature. Once within the canal, the working part 110 is heated by the body temperature that is at or above the transition temperature of the shape memory alloy. The working part 110 acquires the working profile. The latter is adapted for the canal treatment operation. Depending on the shape memory alloy, the working part 110 may become elastic at or above the transition temperature and plastically deformable below the transition temperature.

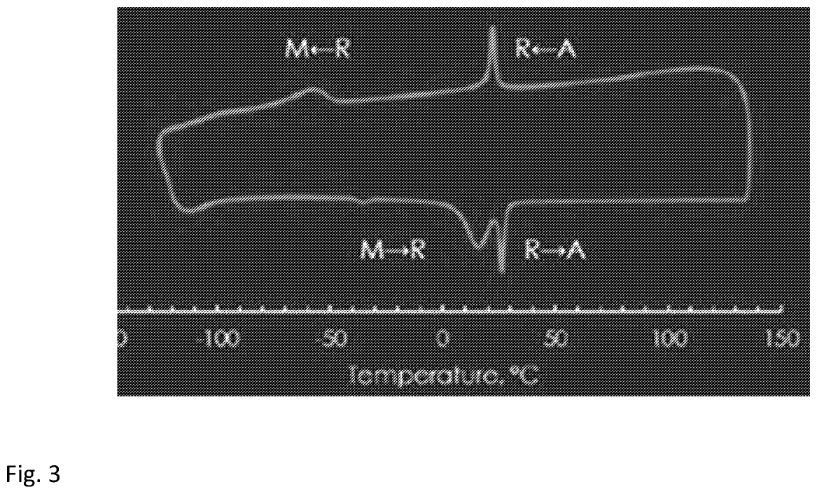

In an embodiment, the endodontic instrument 100 is made from a nitinol alloy (e.g., typically about 56% nickel and about 44% titanium by weight). The nitinol alloy is in an R-phase below a transition temperature, and in an austenitic phase above the transition temperature. In the R-phase, the nitinol alloy is malleable and can be temporarily plastically deformed into a desired shape. The endodontic instrument 100 can also have super elasticity properties, which are obtained by the choice of the alloy and by specific treatments, in particular heat treatments. FIG. 3 shows a graph reporting the transition temperature of a nitinol alloy comprising 56% nickel and about 44% titanium by weight. The nitinol alloy has a first transition temperature for the martensite phase to the R-phase and a second transition temperature for the R-phase to the austenite phase. The first transition temperature is around −60° C.

In an embodiment, the endodontic instrument 100 can be formed by heat treating the nitinol alloy such that its transition temperature is between 15° C. and 45° C. The endodontic instrument 100 can be further formed by memorizing the working profile of the working part 110, namely, the profile comprising the straight apical segment 120, and the apical segment 120 and intermediate segment 130 consisting of the first and second curvatures 131, 132. Such method of forming the endodontic instrument 100 is described in U.S. Pat. No. 9,931,179B2 by the present applicant. Following such method of forming, the working part 110 adopts the working profile when the endodontic instrument 100 transitions from the martensitic phase to the austenitic phase, i.e., when the temperature is at or above the transition temperature of the nitinol alloy.

### Numéros de Référence Employés Sur Les Figures

100 endodontic instrument
101 instrument longitudinal axis
103 apical end
104 shaft
105 shank, handle
110 working part
110 section de travail
120 apical segment
121 tip
125 apical envelope
130 intermediate segment
131 first curvature
132 second curvature
135 intermediate envelope
20 cutting surfaces
α apical taper angle
β intermediate taper angle
A1 first peak
A2 second peak
D1 first distance
D2 second distance

1. An endodontic instrument for cleaning a root canal;
the endodontic instrument is made of a shape memory alloy and has a working part destined to be engaged in the root canal and generally extending along a longitudinal axis between an apical end and a shaft;
the working part has a working profile comprising an apical segment, substantially straight relative to the longitudinal axis, and an intermediate segment, extending between the apical segment and the shaft;
wherein the intermediate segment consists of a first curvature, having a first peak relative to the longitudinal axis, and a second curvature, having a second peak relative to the longitudinal axis and larger than the first peak;
wherein an apical envelope of the apical segment forms an apical taper angle relative to the longitudinal axis, and an intermediate envelope of the intermediate segment, tangent to the first and second peaks, forms an intermediate taper angle relative to the longitudinal axis, the apical taper angle being smaller than the intermediate taper angle.

2. The endodontic instrument according to claim 1, wherein apical segment has a length between 2 and 5 mm.

3. The endodontic instrument according to claim 1, wherein a first distance of the first peak from the apical end is between 5 mm and 8 mm.

4. The endodontic instrument according to claim 1,
wherein a second distance of the second peak from the apical end is between 5 mm and 12 mm.

5. The endodontic instrument according to claim 1,
wherein the apical taper angle is between 0% and 7%.

6. The endodontic instrument according to claim 1,
wherein the intermediate taper angle is between 4% and 30%.

7. The endodontic instrument according to claim 1,
wherein the apical segment is coaxial with the longitudinal axis

8. The endodontic instrument according to claim 1,
wherein the working part is coaxial with the longitudinal axis

9. The endodontic instrument according to claim 1,
wherein the first curvature is curved along the same plane as the second curvature but in an opposite direction.
